(19) United States
(12) Patent Application Publication
(10) Pub. No.: US 2024/0302266 A1
(43) Pub. Date: Sep. 12, 2024

(54) ASSEMBLY FOR A MULTISPECTRAL LIGHT EMISSION, AND MULTISPECTRAL SENSOR EQUIPPED THEREWITH

(71) Applicant: Fraunhofer-Gesellschaft zur Förderung der angewandten Forschung e. V., München (DE)

(72) Inventors: Thorsten GRAUNKE, Erlangen (DE); Wladimir TSCHEKALINSKIJ, Nürnberg (DE); Stephan JUNGER, Erlangen (DE); Jens-Uwe GARBAS, Erlangen (DE)

(21) Appl. No.: 18/548,283

(22) PCT Filed: Mar. 4, 2022
(86) PCT No.: PCT/EP2022/055557

§ 371 Date: Aug. 29, 2023

(30) Foreign Application Priority Data
Mar. 5, 2021 (DE) 10 2021 105 369.2
Apr. 8, 2021 (DE) 10 2021 108 745.7
Mar. 4, 2022 (WO) PCT/EP2022/055557

(51) Int. Cl. G01N 21/25; G01N 21/17; G01N 21/31; G01N 21/3504; G01N 21/3577

(52) U.S. Cl. CPC G01N 21/255; G01N 21/1702; G01N 21/3504; G01N 2021/1704; G01N 2021/3133; G01N 21/3577; G01N 2201/0675

(57) ABSTRACT

The invention relates to an assembly for a multispectral light emission, comprising at least one wide-band light source (1), a filter array (4) of multiple spectral filters, and an optical switch device (2) for controlling the passage of the light emitted from the light source (1) through the filter array (4). In one embodiment, the optical switch device (2) is made of an array of micromirrors (16) or micro-diaphragms and is designed and arranged such that the optical switch can guide light emitted from the light source (1) only through one or more arbitrarily specifiable spectral filters of the filter array (4) in a controlled manner. The invention also relates to a multispectral sensor comprising such an assembly for a multispectral light emission. The assembly allows a multispectral sensor to be provided inexpensively in a miniaturized design with a plurality of spectral channels.

### TECHNICAL FIELD OF APPLICATION

The present invention relates to an assembly for multispectral light emission having at least one wide-band light source that emits light in a spectral range, a filter array made up of a plurality of spectral filters having a spectral width that lies within the spectral range of the light source, and an optical switch device for controlling a passage of the light emitted from the light source through the filter array. The invention also relates to a multispectral sensor equipped with this assembly.

Numerous applications for the selective analysis of e.g. liquid or gaseous media require the use of optical radiation with variable wavelengths or wavelength ranges. Examples are absorption spectroscopy or photo-acoustic spectroscopy. Every gas has a characteristic absorption spectrum with one or more absorption peaks (fingerprint). In photo-acoustic spectroscopy, as a result of the specific light absorption at an absorption peak a pressure change or acoustic wave is formed in the medium that is recorded and converted into an electrical signal. A microphone, for example, can be used as a detector. The recorded pressure change is a measure of the concentration of the corresponding gas. With a photo-acoustic gas sensor (PGS) a large number of substances can be measured in different states of aggregation at very low concentrations. However, the measurements require an adaptation of the wavelength or the wavelength range of the emitted light to the gas to be measured. The excitation wavelength can be adjusted, for example, using a spectral filter or by using a tunable laser. The number of gases that can be measured simultaneously with a photo-acoustic gas sensor correlates with the number of optical spectral channels of this gas sensor.

### STATE OF THE ART

For example, EP 3508 836 B1 discloses a photo-acoustic gas sensor in which light from a wide-band IR light source is guided through a bandpass filter into a measuring chamber containing the gas to be measured. The optical bandpass filter only lets through a certain part of the light spectrum. The central wavelength of the filter is adapted to the absorption maximum of the gas to be detected. Due to temporal modulation of the IR light source at up to 100 Hz, a sound wave is created inside the measuring chamber through the absorption of the light in the gas, which is measured by a highly sensitive pressure sensor on the measuring chamber. The measured amplitude is proportional to the concentration of the absorbing gas. For many applications, such a gas sensor having a small volume, i.e. in a miniaturized form, is required, as can be achieved with the sensor described in EP 3508 836 B1 due to its simple structure. However, the gas sensor of this document is only equipped with a spectral filter, so it can only detect a gas having an absorption maximum at the corresponding filter wavelength.

In principle, it is possible to change the excitation wavelength by using a filter wheel between the excitation light source and the measuring chamber. The number of gases that can be measured simultaneously correlates with the number of available optical spectral channels, i.e. with the number of spectral filters. However, the number of different filters in filter wheels is limited. Due to the mechanical size, miniaturization is very complex and the measurement time increases with the number of filters installed. Another disadvantage of the filter wheel is that only one filter can be used at any one time.

When using a tunable laser as light source, in particular a quantum cascade laser (QCL), no spectral filters are required. The wavelength can be freely adjusted within the tuning range of the laser. For example, by combining several quantum cascade lasers, a wide spectral range can be covered without gaps and a large number of gases can thus be measured. However, quantum cascade lasers are relatively expensive. Due to the need for several quantum cascade lasers to cover a broad spectral range, the costs increase again. In addition, further miniaturization is not possible with such lasers.

For this reason, inexpensive photo-acoustic sensors with only a single bandpass filter are currently known, as in the above-cited EP 3 508 836 B1, with which only one gas can usually be measured. For the selective analysis of complex samples, even in the sub-ppb range, as is made possible by photo-acoustic sensors, no cost-effective solution with a small form factor is available.

The object of the present invention is to specify an assembly for multispectral light emission and a multispectral sensor based thereon, which can be implemented cost-effectively in a miniaturized design. In particular, the assembly is intended to enable a simple and quick adjustment or change of the the emitted wavelengths.

### DESCRIPTION OF THE INVENTION

The object is achieved with the assemblies of claims 1 and 2 and the multispectral sensor according to claim 11. Advantageous configurations of the assemblies and of the multispectral sensor are the subject matter of the dependent claims or can be derived from the following description and the exemplary embodiments.

The proposed assembly for multispectral light emission has at least one wide-band light source, a filter array and a switch device for controlling the passage of at least a portion of the light emitted by the light source through the filter array. The wide-band light source emits light in a specific spectral range. The spectral filters of the filter array have a correspondingly smaller spectral width, which is at least partially within the spectral range of the light source. The spectral width of the spectral filter is preferably less than 1 μm.

In a first alternative of the proposed assembly, the switch device is designed as an optical switch device and light source, filter array and optical switch device are arranged so that light emitted by the light source via the optical switch device, optionally also via other optical elements such as deflection elements or lenses, and the filter array is guided to the outlet of the assembly, at which the correspondingly filtered light emerges from the assembly. The optical switch device comprises an array of micro-mirrors or micro-diaphragms and is designed and arranged so that it can guide the light emitted from the light source specifically only through one or more arbitrarily specifiable spectral filters of the filter array to the outlet of the assembly. The optical switch device can be controlled accordingly for this purpose.

In the second alternative, the light source either has an array of light emitters that can be controlled separately via the switch device and is designed and arranged such that by controlling the light emitters via the switch device, light emitted by the light source can only be guided through one or more arbitrarily specified spectral filters of the filter array. In another embodiment of this second alternative, the light source is formed by a single light emitter and the switch device has a mechanical XY adjustment device for this single emitter or the filter array, by means of which the single emitter can be positioned under different filters of the filter array, so that the light emitted by the light source can be guided through an arbitrarily specifiable spectral filter of the filter array. In this second alternative of the assembly, the light-emitting surface of the light emitters is preferably not larger than the lateral dimensions of the individual spectral filters of the filter array.

In a preferred embodiment, the individual spectral filters of the filter array have small lateral dimensions of ≤10×10 mm. The filter array is preferably designed so that the spectral filters are arranged in rows and columns in the filter array. In principle, however, a different arrangement is also possible, for example a concentric arrangement, a purely linear arrangement or even a completely arbitrary arrangement of the individual filters in the filter array. The arrangement of the individual spectral filters of the filter array preferably correlates with the arrangement of the micromirrors or micro-diaphragms of the first alternative or with the arrangement of the individual light emitters of the array of light emitters of the second alternative, so that they are each arranged in the same way, i.e. corresponding in terms of rows and columns. The number of units provided on the side of the optical switch device or the light source (micromirrors, micro-diaphragms, light emitters) preferably corresponds to the number of spectral filters of the filter array, so that each unit is assigned a spectral filter through which only the light emanating from the assigned unit is passed. There is also the possibility of selecting the number of filters to be greater than the number of these units, wherein each unit is then assigned a group of adjacently arranged spectral filters, for example two or four filters. Furthermore, there is the possibility of selecting the number of filters to be smaller than the number of these units, wherein a plurality of adjacently arranged units are then assigned to each filter.

The proposed assembly allows an adjustment or variation of the wavelength or spectral distribution of the emitted optical radiation according to the number and characteristics of the different filters of the filter array. This allows the spectral distribution of the emitted light to be adjusted for the respective application. The filter array and the light source as well as the optical switch device can be implemented in miniaturized form due to the selected structure. The assembly does not require expensive light sources.

Filters based on sub-wavelength structures or plasmonic filters are preferably used in the filter array. As a result, a large number of filters can be implemented cost-effectively in the smallest space to simulate an absorption spectrum for almost any substance through a suitable combination of the individual optical channels or filters, whereby light is guided through several of the spectral filters at the same time. The filters can also be configured as interference filters and can also be combined with polarization filters. In principle, a combination of these filter types within the filter array is also possible.

In the first alternative, the optical switch device can be implemented together with the light source as a module or also separately from the light source. In the second alternative, the array-shaped light source can in turn be implemented together with the filter array as a module or be formed separately. In both alternatives, a device for avoiding optical crosstalk between the individual optical channels can also be arranged on the beam path between the light source and the filter array, for example in the form of a suitably designed diaphragm and/or lens array.

With the proposed assembly a multispectral sensor with a measuring chamber, into which light emerging from the assembly is coupled, and one or more detectors can be achieved, by means of which the result of an interaction of the light coupled into the measuring chamber with a medium introduced into the measuring chamber can be detected. For example, the multispectral sensor can be configured as a photo-acoustic gas sensor, in which at least one of the detectors is then a pressure sensor, for example, a microphone. In this case, the light source of the proposed assembly is then suitably time-modulated during a measurement in order to generate sound waves due to the absorption of light coupled into the measurement chamber in the gas to be measured. A larger number of gases or gas components can then be measured with this gas sensor according to the number of filters in the filter array. Other applications, such as absorption spectroscopy, also in combination with photo-acoustic spectroscopy can be achieved with such a multispectral sensor.

The proposed assembly and the multispectral sensor equipped therewith can be used in many areas of application, for example in medicine, in the environmental sector, in process engineering and in civil security. This includes, for example, the analysis of industrial processes and parameters (process monitoring), quality assurance, early fire detection, aroma analysis, the detection of mal-odours, breath gas analysis, safety applications, environmental analyses, non-destructive surface examinations via reflection measurement, an application as an electronic nose or electronic tongue. Of course, this is not an exhaustive list.

### BRIEF DESCRIPTION OF THE DRAWINGS

The proposed assembly and the multispectral sensor equipped therewith are described hereinafter in further detail with reference to exemplary embodiments in connection with the drawings. In the figures:

FIG. 1 shows a schematic representation of a multispectral sensor according to the present invention with an optical switch device;

FIG. 2 shows an example of a flexible adjustment of the light spectrum with the proposed assembly to the absorption spectrum of a gas to be measured;

FIG. 3 shows a schematic representation of a multispectral sensor according to the present invention with an array-shaped light source;

FIG. 4 shows an example of an embodiment of the proposed assembly based on an array-shaped light source;

FIG. 5 shows a further example of an embodiment of the proposed assembly based on an array-shaped light source;

FIG. 6 shows an example of an embodiment of the proposed assembly with a micro-diaphragm array as an optical switch device;

FIG. 7 shows an example of an embodiment of the proposed assembly based on a single emitter with a mechanical XY adjustment device;

FIG. 8 shows a first example of a structure of the proposed multispectral sensor;

FIG. 9 shows an example of an embodiment of the proposed assembly with a micromirror array as the optical switch device;

FIG. 10 shows an example of a micromirror array in which the spectral filters of the filter array are applied to the micromirrors;

FIG. 11 shows a second example of a structure of the proposed multispectral sensor;

FIG. 12 shows an example of an embodiment of the proposed multispectral sensor with multiple measurement chambers;

FIG. 13 shows an example of a filter array that can be used in the proposed assembly; and

FIG. 14 shows an example of an embodiment of a spectral filter of the filter array with polarization filters that can be used in the proposed assembly.

### WAYS TO CARRY OUT THE INVENTION

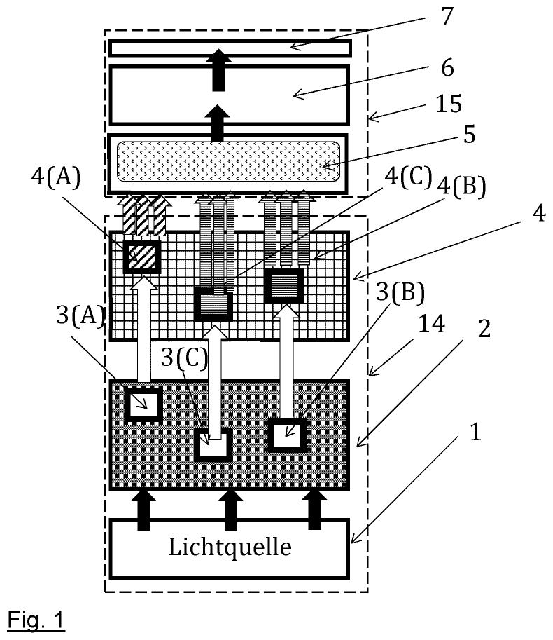

The structure of a multispectral sensor according to the present invention is shown highly schematically in FIG. 1, which is composed of the proposed assembly for multispectral light emission 14 and a measuring device 15. Light of the desired spectral distribution generated by the assembly 14 exits at the outlet of this assembly and enters into the measuring device 15, as indicated in the figure. The assembly for multispectral light emission 14 comprises a wide-band light source 1, a device referred to hereinafter as an optical switch array 2 and a filter array 4. The measuring device 15 has a measuring chamber 5, one or more receivers 6 and an electronic device 7 for signal processing and evaluation. Light from the light source 1 is guided to the filter array 4 via the optical switch array 2 (optical switch device). The optical switch array 2 is designed so that it guides the light onto one or more selected filters 4(A), 4(B), 4(C).

In an embodiment using transmission, the optical switch array 2 is implemented by a micro-diaphragm array, in which each element 3(A), 3(B), 3(C), hereinafter referred to as an optical switch, represents a micro-diaphragm, which can each be controlled independently of the others for opening and closing. A control for changing the opening diameter (with an open diaphragm) is preferably also possible. The light is then guided to one or more of the filters of the filter array 4 via the respectively selected micro-diaphragms. The remaining diaphragms are closed.

In an embodiment using reflection, the optical switch array 2 is designed as a micromirror array. Each element of the switch array is a micromirror. The mirrors can in turn be controlled individually such that the incident light is guided onto one or more filters 4(A), 4(B), 4(C) of the filter array 4. The other mirrors are set such that they do not guide the incident light onto the filter array 4. Areas between the micromirrors (or micro-diaphragms in the above case) are designed to be not transparent to the light.

The filter array 4 consists of several spectral filters. In the example shown in FIG. 1, only the filters or filter elements 4(A), 4(B), 4(C) are exposed and thus only allow certain wavelengths to pass according to the filter characteristics of these filters and enter into the measuring chamber 5. Any filter of the filter array 4 can be successively or simultaneously trans-illuminated with light using the optical switch array 2 in order to generate an optimal spectrum for the respective measurement task. As an example, as in a measurement with a monochromator, the required filters can be successively activated or exposed. For example, by only actuating the element 3(A) to expose filter the 4(A), light of a single wavelength can be generated if filter 4(A) is designed with a correspondingly narrow bandwidth.

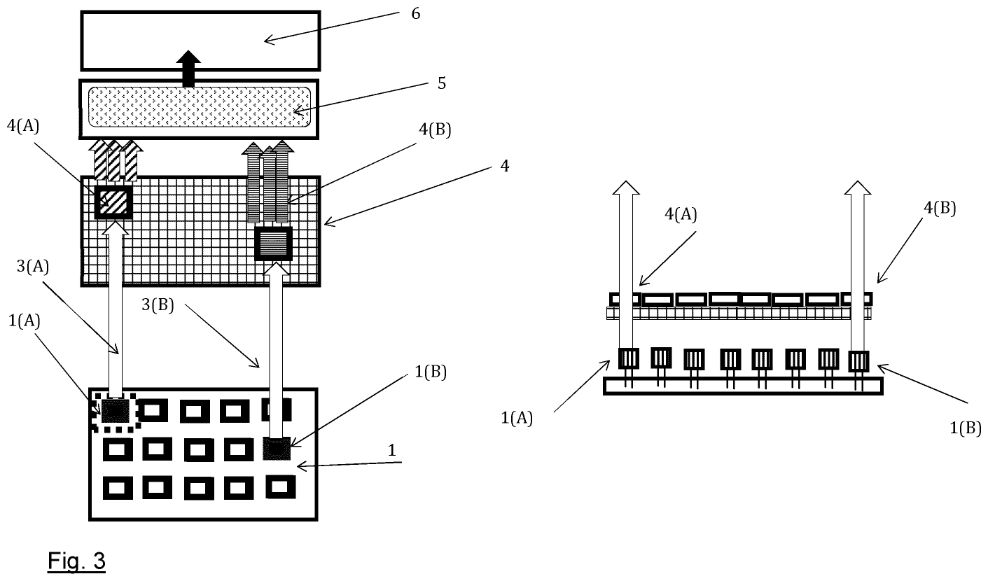

In a further embodiment, the light source 1 can be configured as an array of light emitters, as is described in further detail hereinafter in connection with FIG. 3. The individual light emitters can be arbitrarily actuated in order to guide light to one or more filters of the filter array 4 in a targeted manner. Preferably, the light source and the filter array here form a unit. In this embodiment, no optical switch array 2 is required.

The sample to be measured is located in the measuring chamber 5. It can be present in different states of aggregation, for example as a liquid or as a gas. The measurement can take place in reflection or in transmission. Different sensors or detectors with different physical measurement principles can be used as receivers 6. Examples are IR detectors for absorption spectroscopy or a pressure sensor, for example, in the form of one or more MEMS microphones, in photo-acoustic spectroscopy. A combination of several detectors or sensors is also possible, for example, the use of a pressure sensor in a transparent measuring chamber in conjunction with an absorption detector outside the measuring chamber.

In a measurement, one or more filters of the filter array 4 can be used as desired by suitable activation of the switch array 2 or the light emitters in the case of an array of light emitters, in order to thereby generate a desired spectral distribution, for example only a single wavelength or a superposition of certain wavelengths, and to be able to use it for the application. A change in this spectral distribution is possible at any time by a different activation. The activation, the output of the recorded data, the signal processing and evaluation are implemented via electronics and software.

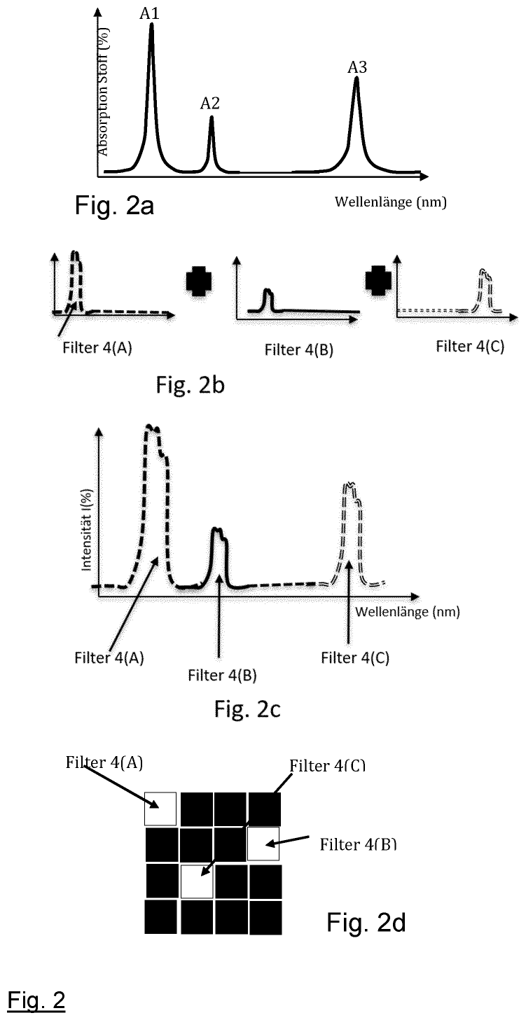

The light spectrum generated by the proposed assembly can thus be flexibly adapted to the absorption spectrum of a sample in the measuring chamber. FIG. 2 shows an example of such a flexible adaptation. For this purpose, FIG. 2a shows an abstract absorption spectrum of a substance to be measured. This substance has three characteristic absorption peaks (A1, A2, A3). This absorption spectrum can be simulated by means of a combination of suitable elements of the optical switch array 2 and the filter array 4. In the present example, the optical switches 3(A), 3(B), 3(C) are open and the filters 4(A), 4(B) and 4(C) from the filter array 4 are thereby exposed. In certain configurations, not only the positions of the individual absorption peaks can be simulated, but the amplitude ratios between the peaks can also be adjusted. FIG. 2b shows the three individual spectra of the filters 4(A), 4(B), 4(C). The simultaneously exposed filters of the filter array 4 are shown in white in FIG. 2d, the unexposed ones in black. FIG. 2c shows the complete spectrum 4(A)+4(B)+4(C) of the light after the filter array 4. This light spectrum is optimally adapted to the absorption spectrum of the substance to be measured shown in FIG. 2a. An intensity adjustment can be set by means of an adjustment of parameters such as the current for the individual light emitters when using a light emitter array without an optical switch array or by means of the transmittance of the optical switch array. The latter relates in particular to the use of a micro-diaphragm array with adjustable diaphragm opening or the use of a micro-diaphragm array based on liquid crystals, in which the transmittance can be adjusted.

FIG. 3 shows an example of an embodiment of the proposed multispectral sensor and the assembly used for multispectral light emission, in which the light source 1 is formed by an array of a plurality of individual light emitters 1(N). The structure of the multispectral sensor is shown schematically in the left-hand partial image, and the structure of the associated assembly is shown in the right-hand partial image. In this embodiment, no optical switch device is required as in FIG. 1. The individual light emitters of the array-shaped light source 1 can be activated individually or switched on and off as required. This enables a flexible adaptation of the light spectrum emitted by the assembly to the absorption spectrum of the sample to be measured in the same way as has already been explained in connection with FIGS. 1 and 2. In the example of FIG. 3, the two light emitters 1(A), 1(B) are switched on, the other light emitters of the light source 1 are switched off. As a result, only the filters 4(A) and 4(B) are exposed on the filter array 4 arranged thereabove, as indicated schematically in the figure. In this example, the light-emitting surfaces of the light emitters 1 have an extent that is smaller than the dimensions of the filters 4(N) of the filter array 4, as is indicated in the right-hand partial image of FIG. 3. As a result of sufficiently small distance between the filter array 4 and the light source 1 then, by suitably activating the individual light emitters 1(N), only those filters of the filter array 4 that are located exactly above the respective light emitter are exposed.

An array of IR light sources which emits light in a spectral range from 1 μm to 15 μm is preferably used here as the light source 7. Thus, for example, a gaseous sample in the measuring chamber 5 can be measured by photo-acoustic spectroscopy. One or more pressure sensors, for example in the form of one or more microphones, are then used as receivers 6. Thus, in the embodiment according to FIG. 3 an array of so-called micro-heaters can be used as an array-shaped light source, as for example in L. D. Williams et al., “Design and characterization of a microheater array device fabricated with SWIFT-Lite™”, J. Micro/Nanolith. MEMS MOEMS 7(4), 043035 (2008). Such an array can be manufactured using MEMS technology.

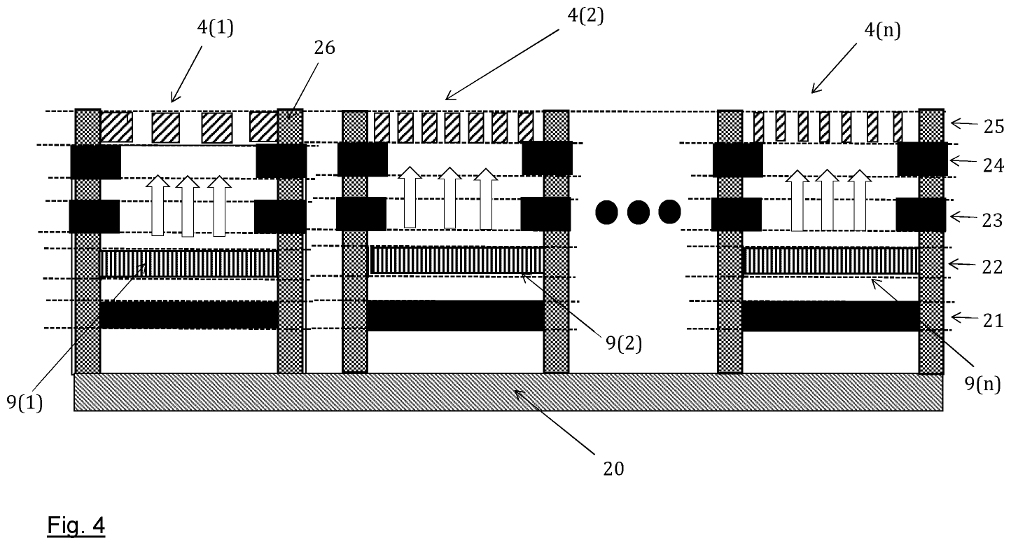

FIG. 4 shows a further example of an assembly for multispectral light emission with an array-shaped light source. Such an assembly could therefore also be used in a multispectral sensor according to FIG. 3. In this example, the filter array and the array-shaped light source form a unit. For this purpose, FIG. 4 shows an array of monolithically constructed spectral channels for this purpose. A spectral channel is a combination of light source and light emitters 9(1), 9(2) . . . 9 (n) and filters 4(1), 4(2), . . . 4 (n) of the filter array. The array shown in FIG. 4 can be produced using semiconductor technology or by post-processing. In this way, the desired number of spectral channels can be arranged as an array on a substrate 20. Both the individual filters, which can be configured, for example, as plasmonic filters or filters based on sub-wavelength structures, and also the light source, for example, in the form of MEMS microheaters, can be implemented using semiconductor technology. The filters here can consist of one or more structured metal layers or dielectric layers. FIG. 4 shows a cross-section of such a unit. The layered structure of multiple layers 21-25 on the substrate 20 with the via throughs or vias 26 can be clearly seen from the figure, as is frequently used in semiconductor processes. In this example, layer 22 represents the IR light source array with light emitters 9(1), 9(2) . . . 9 (n). The IR light sources can, for example, be implemented by micro-spirals or microheaters. The filter array with the filters 4(1), 4(2) . . . 4 (n) is implemented in the uppermost layer 25. Each filter can be constructed of one or more individual layers. The filter layers can be constructed of at least one array-shaped metal layer structured in sub-wavelength dimensions or a dielectric layer. The filter properties can be freely defined for each spectral channel. The optical properties of the filters depend on the structure size, the structure shape (e.g. holes or islands) and the periodicity and can be defined via the filter design. The filter arrays in the configurations with an optical switch device can be implemented in this way. The layer 21 represents one of the layers of a typical layer structure in a semiconductor process and can, for example, also serve as a reflector for the light source in layer 22. Suitable openings for the passage of light are formed in the layers 23, 24. As a rule, these layers each consist of a metallic material and are separated from one another by dielectric layers. The vias 26 prevent light from crossing between the individual spectral channels in this array.

Examples of suitable infrared optical filters can be found in I. J. H. McCrindle et al., “Infrared plasmonic filters integrated with an optical and terahertz multi-spectral material”, Phys. Status Solidi A 212, No. 8, 1625 to 1633 (2015) and in A. Wang et al., “Mid-infrared plasmonic multispectral filters”, Scientific Reports (2018) 8: 11257. The filters presented in these publications are based on structured metal layers and can be modelled via finite difference time domain (FDTD). As a result of the simulation, the design of the filters for the desired spectral transmission, the bandwidth and the position of the central wavelength can be determined.

FIG. 5 shows a modification of the multispectral light emission assembly of FIG. 3. Since the light source 1 and filter array 4 are manufactured separately in this assembly and are arranged one above the other, a free space is formed between the light source 1 and the filter array 4. In order to prevent optical crosstalk between the individual optical channels, in the example of FIG. 5 a suitably designed diaphragm or lens array 8 is arranged in this free space, which prevents optical crosstalk between the individual channels. Without this diaphragm or lens array 8, the light from a light emitter could possibly not only impinge on the filter located directly above it, but also on neighbouring filters. For example, through the use of this diaphragm or lens array 8, the light from the light emitter 1(B) only impinges upon the filter 4(B) located thereabove. Without the diaphragm or lens array 8, due to the large emission angle of the light emitter 1(B), its light would also impinge upon neighbouring filters, for example, on filter 4(C).

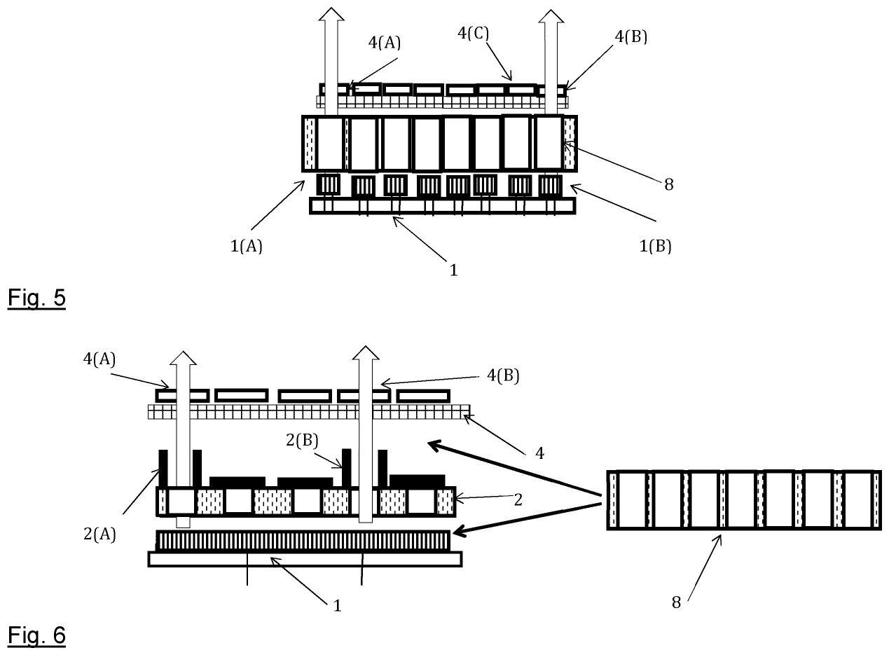

FIG. 6 shows an example of an assembly for multispectral light emission, in which a micro-diaphragm array is used as the optical switch array 2 above the light source 1. Such a micro-diaphragm array can be manufactured, for example, in MEMS technology, as is known, for example, from M. J. Li et al., “Fabrication of Microshutter Arrays for Space Application”, Proceedings of SPIE vol. 4407 (2001), 295 to 303. In the example of FIG. 6, the shutters or microshutters 2(A) and 2(B) are opened and the filters 4(A) and 4(B) are exposed. The remaining micro-diaphragms are closed and the associated filters are not exposed. The elements of the diaphragm array can be activated individually or as a group to open and close. As a result, the light spectrum emitted by the assembly can be flexibly adapted to the absorption spectrum of a sample as in the preceding examples. The micro-diaphragm or optical switch array 2 and the light source 1 located underneath can be implemented as a unit. In order to avoid crosstalk between individual channels, an additional diaphragm or lens array 8 can also be arranged here both between light source 1 and optical switch array 2 and between optical switch array 2 and filter array 4, as indicated in the left-hand partial image of FIG. 6.

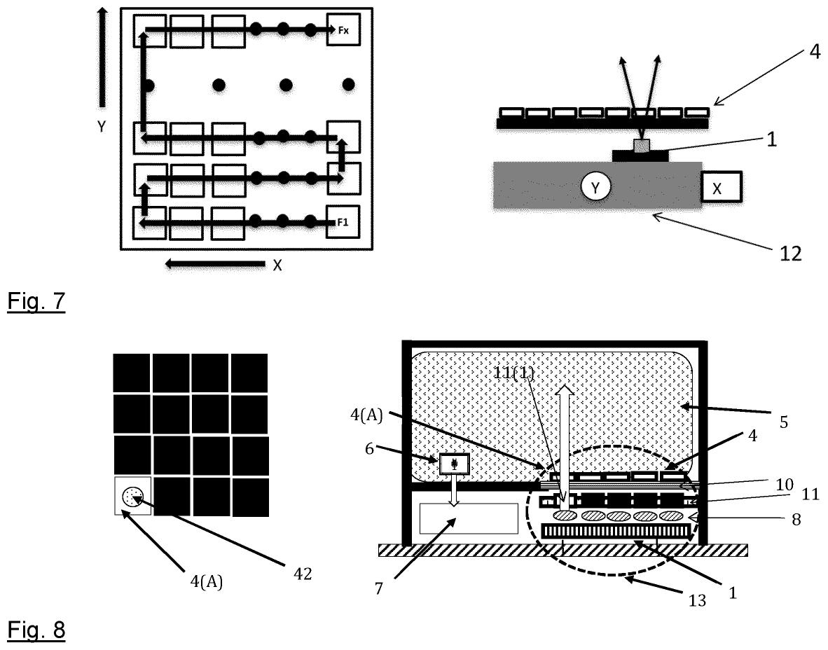

FIG. 7 shows another example of a possible configuration of the proposed assembly for multispectral light emission. In the example in FIG. 7, a single light emitter is used as the light source 1, which can be moved under the filter array 4 via a mechanical XY adjuster 12. A diaphragm or lens array 8 can also be integrated here, as in some of the preceding exemplary embodiments, in order to avoid optical crosstalk. As a result, the beam angle is limited and no adjacent filter is undesirably exposed. In the present example, the filter array 4 is located on a substrate that is transparent to the light from the light source, for example, made of Si in the case of an IR light source. The light source 1 is located on the XY adjuster 12. The filter array 4 is scanned with the light source 1 depending on the desired filter or the resulting spectral characteristics. Different spectral characteristics can thus be generated successively, as indicated schematically in the left-hand partial image of FIG. 7 in a plan view of the filter array 4. The small travel of the XY adjuster with correspondingly small lateral dimensions of the individual filters of the filter array 4 can be achieved, for example, by means of a piezo drive. Alternatively, the light source 1 can also be arranged in a fixed position and the filter array 4 can be moved over the light source. In the example in FIG. 7, the filters F1 to Fx of the filter array 4 are scanned one after the other.

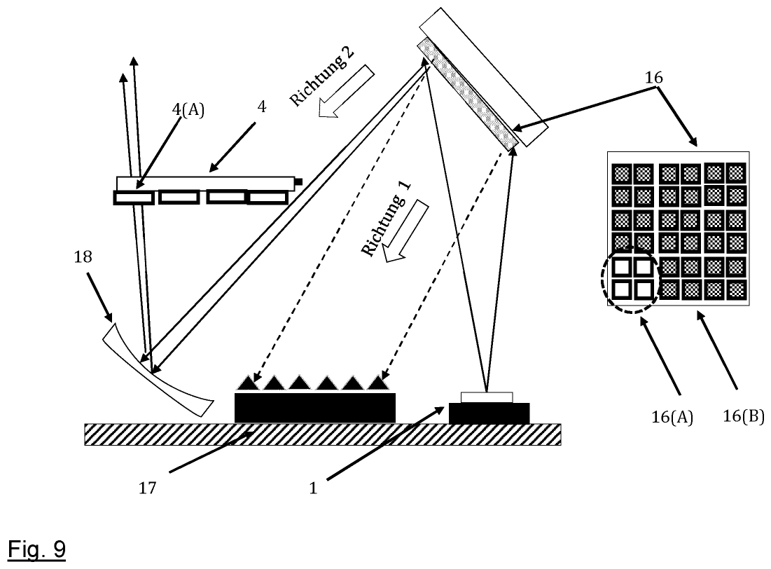

FIG. 8 shows an example of a photo-acoustic gas sensor (PGS) such as can be implemented according to the present invention. The assembly for multispectral light emission, implemented by the module 13 in FIG. 8, can in principle be implemented as in one of the exemplary embodiments explained hereinbefore and, in this example, has a micro-diaphragm array 11 as the optical switch device. In this example, a lens array 8 is arranged between the light source 1 and the micro-diaphragm array 11, which prevents crosstalk between the individual spectral channels. The lenses of this lens array 8 collimate or focus the light emitted by the light source 1 in the direction of the respective micro-diaphragm. In this example, the electronics of the gas sensor are separate from the measuring chamber 5. The measuring chamber has an optical window 10 for coupling in the excitation radiation. In this example, the filter substrate of the optical filter array 4 is used as the optical window 10. The filters of the filter array can be arranged above or below this optical window. In the present example, the filters are arranged above the optical window 10, i.e., within the measuring chamber 5. A pressure sensor is located in the measuring chamber 5 as a receiver 6, for example, in the form of a MEMS microphone. The output signal from this microphone is evaluated in the signal processing and evaluation device 7 (electronics, software). A plan view of the filter array 4 is shown in the left partial image of FIG. 8. For example, filter 4(A) is exposed (spot 42) on the filter array. The other filters of the filter array 4 are not exposed. As explained in the previous exemplary embodiments, several filters can naturally also be exposed at the same time. In a PGS sensor, an IR light source is usually used as the light source 1, which emits light in the wavelength range from 1 to 15 μm. The measuring chamber 5 has at least one inlet for the supply of the sample. Further sensors, for example for temperature and humidity, can also be located in the measuring chamber 5.

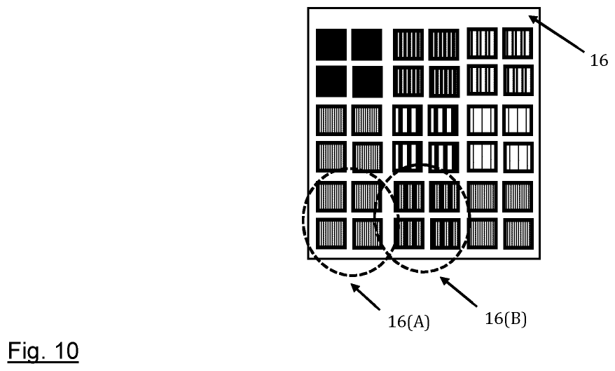

FIG. 9 shows another example of a multispectral light emission assembly according to the present invention. In this example, a micromirror array 16 is used as the optical switch array. This mirror array 16 can be a DLP module (MEMS), for example. In this module, individual mirrors or mirror areas, i.e. areas with several mirrors, can be switched on and off or tilted accordingly. The individual mirrors of the module can be made very small, for example with dimensions of 10×10 μm. In the example of FIG. 9, the individual mirrors of the mirror array 16 guide the light either in direction 1 or in direction 2. The light from a light source 1 irradiates the mirror array 16. When deflected in direction 2, the respective light beam is guided via an optical system 18, for example a concave mirror, onto the optical filter array 4 and exposes the filter 4(A), for example, as outlined in FIG. 9. The optical system 18 is based on either lens optics or mirror optics. Mirror optics are preferred since the mirror coating enables very low absorption over a very broad spectral range. The individual filters of the filter array 4 are selected via the switched-on areas of the optical mirror array. In the present example, mirror or mirror area 16(A) is switched on, thus deflecting the incident light in direction 2. The mirror or mirror area 16(B) is switched off, so that the associated mirror or mirrors deflect the light in direction 1 onto an absorber 17 in which the deflected light is absorbed. The desired filters of the filter array 4 can therefore be exposed by suitably activating the individual mirrors of the mirror array.

Alternatively, the filter array 4 with the individual filters, preferably plasmonic filters, can also be applied directly to the mirrors of the mirror array 16, as indicated schematically in FIG. 10. A separate filter array 4 as in the left-hand part of FIG. 9 is then not required.

The filter array and the MEMS mirror array can be implemented together using semiconductor technology. The respective filter can consist of one or more structured metal layers or dielectric layers. FIG. 10 shows an example of such a micromirror array 16 with applied filters in a plan view. In this example, four of the mirrors are combined into a group or a mirror area 16(A), 16(B) . . . 16(n), which are each coated with the same filter. This is indicated in FIG. 10 by the respective pattern. Filters based on sub-wavelength structures or plasmonic filters are preferably used as filters. Thus, a reflection spectrum can then be simulated for almost any substance to be measured by a combination of different mirror areas 16(A), 16(B) . . . 16(n). The corresponding mirrors are only switched on for this purpose, i.e. they reflect the incident radiation into the measuring chamber. A specific filter that is optimized for a specific wavelength can be applied to each mirror area. A mirror area can consist of ≥1 mirrors, in the example in FIG. 10, four mirrors.

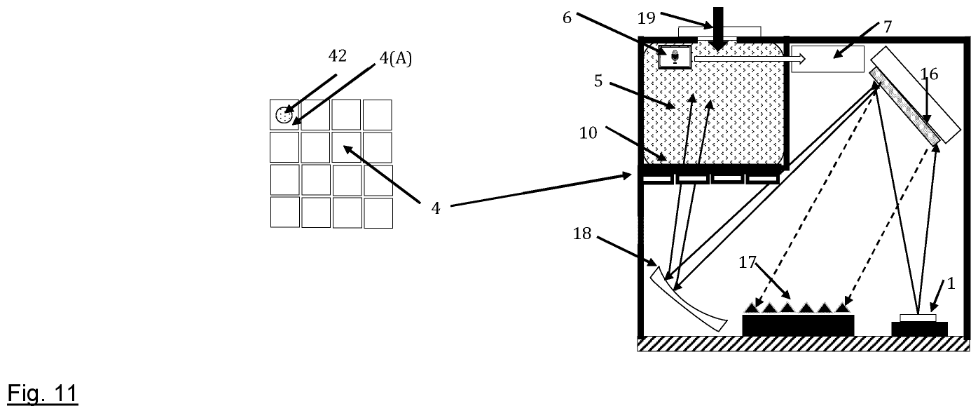

FIG. 11 shows an example of an embodiment of a photo-acoustic gas sensor with the assembly for multispectral light emission shown in FIG. 9 or 10. In this example, the electronics and the optics are separated from the measuring chamber 5. The measuring chamber has an optical window 10, which is also formed by the filter substrate of the optical filter array 4 in this example. The filters of the filter array can in turn be arranged above or below the optical window 10. In the present example, the filters are arranged below the optical window 10, i.e., they are located outside the measuring chamber. At least one pressure sensor is located in the measuring chamber 5 as a receiver 6, which can be configured as a MEMS microphone, for example. The output signal of this pressure sensor is evaluated in the signal processing and evaluation device 7 (electronics, software). A plan view of the filter array 4 is shown in the left-hand partial image of FIG. 11. For example, filter 4(A) is exposed on the filter array (spot 42). The other filters in the array are not exposed. As shown in the previous exemplary embodiments, naturally a plurality of filters can also be exposed at the same time. In a PGS sensor, the light source 1 is usually an IR light source that emits in a wide range between 1 and 15 μm. The measuring chamber 5 in turn has at least one inlet 19 for feeding in the sample. Other sensors can also be located in the measuring chamber, for example for measuring temperature and humidity.

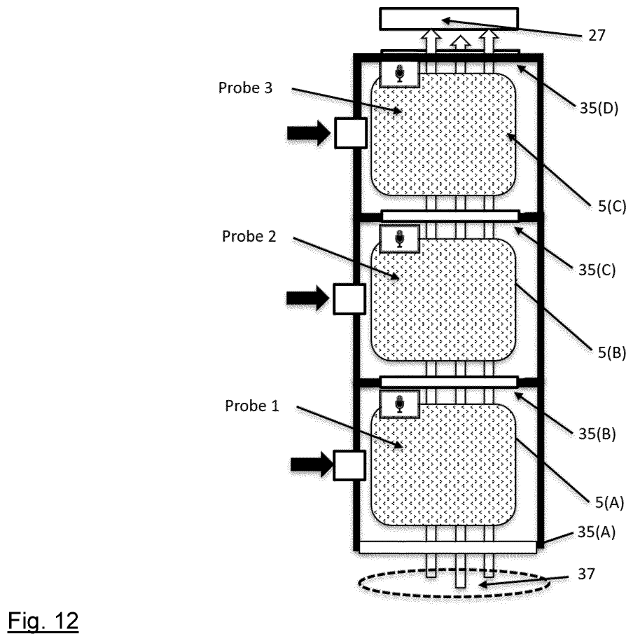

FIG. 12 shows an example of a structure of a multispectral sensor according to the present invention, in which more than one measuring chamber is used. In this example, three measuring chambers 5(A), 5(B), 5(C) are installed in series. This is possible because when measuring gases due to the weak gas absorption excitation light emitted into the measuring chambers is only slightly attenuated when passing through the measuring chambers. The measuring chambers each have optical windows 35(A), 35(B), 35(C), 35(D). The bundle of rays 37 emitted from the assembly for multispectral light emission propagates through the individual chambers 5(A), 5(B), 5(C). A radiation receiver 27 can be installed after the last chamber. Fluctuations of the light output can thus be measured. Different samples can be fed to the measuring chambers. These can be unknown gases or calibration gases. A calibration gas has a defined concentration and a known spectrum. A multiport sampler can be implemented by using several measuring chambers. An IR detector or a photodiode, for example, can be used as the radiation receiver 27.

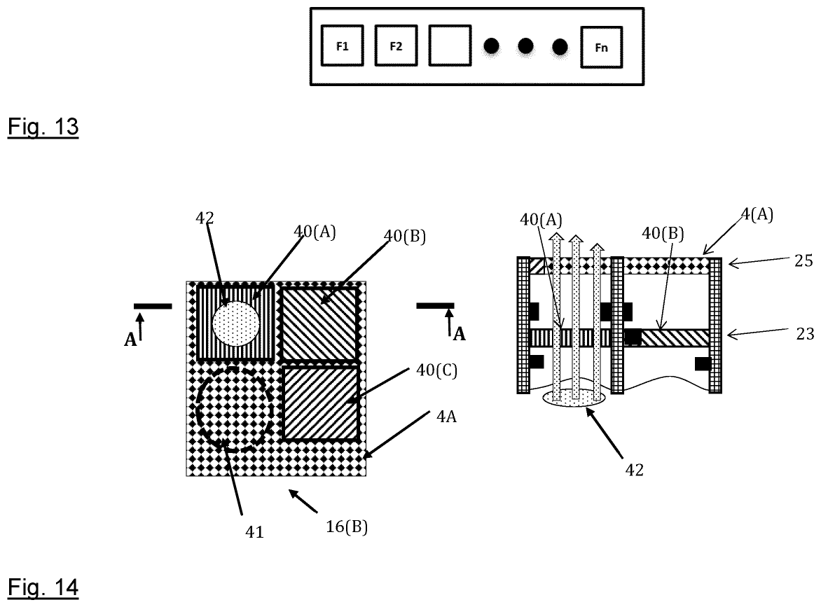

FIG. 13 shows an example of a filter array, as can also be used in the proposed assembly and the proposed multispectral sensor. Such a filter array, in the present example in the form of an “infrared linear variable filter” such as is commercially available from Vortex Optical Coatings Ltd., for example, can be produced using thin-film technology. This type of filter has multiple spectral channels (bandpass filters) and can be optimized in a specific spectral range. The filter array 4 from the previous exemplary embodiments can be replaced by such a filter. The filters F1, F2, Fn can be exposed individually or as a group via an optical switch.

In the proposed assembly for multispectral light emission and the associated multispectral sensor, the spectral filters can also be combined with polarization filters. FIG. 14 shows a combination of a spectral filter with multiple polarizing filters. Absorption and scattering spectra of substances can depend on the state of polarization of the light. For this reason, additional information about a substance can be obtained through polarized spectral illumination. In the previous exemplary embodiments, unpolarized light was used in each case. In the present example, a spectral channel or filter 4(A) is combined with several polarization filters 40(A), 40(B), 40(C). No polarizing filter is located at position 41. This position represents a reference channel with unpolarized light. The filters 40(A), 40(B), 40(C) can be exposed successively via the optical switch array. In this example, spot 42 is located on polarizing filter 40(A). The light after the spectral filter 4(A) always has the same spectrum but can be polarized differently depending on the local exposure. An example of a structure of such a filter in semiconductor technology is shown in the right-hand partial image. The basic structure has already been explained in connection with FIG. 4. In this example, lattice-like structures are achieved in the metal layer 23. These lattice-like metal bars polarize the light depending on the angle. In the present example, angles of +90°, +45° and −45° are used. A spectral filter 4(A) is constructed thereabove in layer 25. This can be based on sub-wavelength structures, for example.

### REFERENCE LIST

1 Light source
1(N) Light emitter
2 Optical switch array
2(N) Micro-diaphragms
3(N) Switch array elements
4 Filter array
4(N) Selected filters
5 Measuring chamber
6 Receiver
7 Signal processing and evaluation device
8 Lens or diaphragm array
9(N) Light emitter
10 Optical window
11 Micro-diaphragm array
12 XY adjuster
13 Module
14 Assembly for multispectral light emission
15 Measuring device
16 Micromirror array
16(N) Micromirror, micromirror area
17 Absorber
Optical system 18
19 Inlet
20 Substrate
21-25 Layers
26 Via through (Via)
27 Radiation receiver
35 Optical window
37 Bundle of rays
40 Polarization filter
41 Position on spectral filter
42 Exposure spot

1. Assembly for multispectral light emission comprising at least
a wide-band light source (1) that emits light in a spectral range,
a filter array (4) made up of a plurality of spectral filters having a spectral width which lies at least in part within the spectral range of the light source (1), and
an optical switch device (2) for controlling a passage of the light emitted by the light source through the filter array (4), which are arranged such that the light emitted by the light source (1) is guided via the optical switch device (2) and the filter array (4) to an outlet of the assembly,
wherein the optical switch device (2) comprises an array of micromirrors (16) or micro-diaphragms and is designed and arranged in such a way that it can selectively guide the light emitted by the light source (1) only through one or more arbitrarily specifiable spectral filters of the filter array (4) to the outlet of the assembly.

2. Assembly for multispectral light emission comprising at least
a wide-band light source (1) that emits light in a spectral range,
a filter array (4) of multiple spectral filters having a spectral width that is at least partially within the spectral range of the light source (1), and
a switch device for controlling passage of the light emitted by the light source (1) through the filter array (4),
wherein the light source (1)
comprises either an array of light emitters controllable separately via the switch device and is designed and arranged in such a way that by activating the light emitters via the switch device, the light emitted by the light source (1) can be guided in a targeted manner only through one or more arbitrarily specifiable spectral filters of the filter array (4),
or is formed by at least one individual emitter and the switch device has an XY adjustment device (21) for the individual emitter or the filter array (4), by means of which the individual emitter can be positioned under different filters of the filter array (4), so that the light emitted from the light source (1) can only be guided through an arbitrarily specifiable spectral filter of the filter array (4).

3. Assembly according to claim 2,
characterized in
that the filter array (4) is arranged directly above the array of light emitters that can be activated separately via the switch device.

4. Assembly according to claim 3,
characterized in
that each combination of one or more light emitters with a spectral filter of the filter array (4) arranged directly above represents an optical channel and a device for avoiding optical crosstalk is arranged between the array of light emitters which can be controlled separately via the switch device and the filter array (4).

5. Assembly according to claim 1,
characterized in
that each combination of one or more elements (3) the optical switch device (2) and an associated spectral filter of the filter array (4) represents an optical channel and a device (8) for preventing optical crosstalk between the optical channels is arranged between the light source (1) and the filter array (4).

6. Assembly according to claim 1,
characterized in
that the individual spectral filters of the filter array (4) have small lateral dimensions of ≤10×10 mm.

7. Assembly according to claim 1,
characterized in
that the filter array (4) is a filter array based on sub-wavelength structures or a plasmonic filter array.

8. Assembly according to claim 1,
characterized in
that the spectral filters are arranged in rows and columns in the filter array (4).

9. Assembly according to claim 1,
characterized in
that when the optical switch device (2) is designed as an array of micromirrors (16), the filters of the filter array (4) are applied directly to the micromirrors.

10. Assembly according to claim 1,
characterized in
that the spectral filters in the filter array (4) are combined with polarization filters (40).

11. Multispectral sensor comprising
an assembly according to claim 1,
a measuring chamber (5) into which light emerging from the assembly is coupled, and
one or more detectors (6) by means of which a result of an interaction of the light coupled into the measuring chamber (5) and a medium introduced into the measuring chamber (5) can be detected.

12. Multispectral sensor according to claim 11,
characterized in
that an inlet window (10) of the measuring chamber (5) is formed by a carrier substrate of the filter array (4) of the assembly.

13. Multispectral sensor according to claim 11,
which is designed as a photo-acoustic sensor, in particular as a photo-acoustic gas sensor.

14. Multispectral sensor according to claim 11,
which is designed as an absorption sensor or as a combined absorption and photo acoustic sensor.

15. Multispectral sensor comprising
an assembly according to claim 2,
a measuring chamber (5) into which light emerging from the assembly is coupled, and
one or more detectors (6) by means of which a result of an interaction of the light coupled into the measuring chamber (5) and a medium introduced into the measuring chamber (5) can be detected.

16. Multispectral sensor according to claim 15,
characterized in
that an inlet window (10) of the measuring chamber (5) is formed by a carrier substrate of the filter array (4) of the assembly.

17. Multispectral sensor according to claim 15,
which is designed as a photo-acoustic sensor, in particular as a photo-acoustic gas sensor.

18. Multispectral sensor according to claim 15,
which is designed as an absorption sensor or as a combined absorption and photo acoustic sensor.

19. Multispectral sensor according to claim 11,
characterized in
that the filter array (4) of the assembly is a filter array based on sub-wavelength structures or a plasmonic filter array.

20. Multispectral sensor according to claim 15,
characterized in
that the filter array (4) of the assembly is a filter array based on sub-wavelength structures or a plasmonic filter array.

21. Assembly according to claim 2,
characterized in
that the filter array (4) is a filter array based on sub-wavelength structures or a plasmonic filter array.
